(19) United States
(12) Patent Application Publication
(10) Pub. No.: US 2006/0173598 A1
(43) Pub. Date: Aug. 3, 2006

(54) Method for firing restraining means

(76) Inventors: Maike Moldenhauer, Waldenbuch (DE); Petar Lesic, Ludwigsburg (DE); Thomas Rank, Ludwigsburg (DE); Marc Theisen, Besigheim (DE); Frank Mack, Stuttgart (DE); Morten Trachterna, Kzunmachnow (DE); Thomas Lich, Schwaikheim (DE); Michael Roelleke, Leonberg-Hoefingen (DE); Rainer Bitzer, Weissach (DE)

Correspondence Address: KENYON & KENYON LLP, ONE BROADWAY, NEW YORK, NY, 10004, US

(21) Appl. No.: 10/543,821

(22) PCT Filed: Oct. 6, 2003
(86) PCT No.: PCT/DE03/03306

§ 371 Date: Jan. 12, 2006

(30) Foreign Application Priority Data
Jan. 28, 2005 (DE) 103 03 147.2

(51) Int. Cl. E05F 15/00; B60R 22/00

(52) U.S. Cl. 701/45

(57) ABSTRACT

A method for triggering restraint devices is described in which various algorithms determine values as a function of at least one sensor signal, which are combined to form a measure, and in which the restraint devices are triggered as a function of the measure influenced by at least one signal from a passenger-compartment sensor system.

### FIELD OF THE INVENTION

The present invention relates to a method for triggering restraint devices.

### BACKGROUND INFORMATION

German Published Patent Application No. 100 59 426 describes the combination of crash severity and occupant classification in a triggering algorithm for generating a triggering decision. The crash severity is determined according to the specific crash type.

### SUMMARY

By contrast, an example method according to the present invention for triggering restraint devices may allow for a more optimal determination of the triggering time and of the restraint devices to be used by evaluating various algorithms of the sensor signals. In particular, the example method according to the present invention may have a scalable and modular structure such that arbitrary algorithms may be combined with one another. This may make the modification of the example method according to the present invention simple and robust, since a modification of the example method, for example the addition of an algorithm, may not entail a modification of the entire method.

The triggering time and which restraint devices should be triggered to what degree may be determined as a function of the measure determined by the individual algorithms. A better adaptation to the crash and to the occupants of the vehicle may be achieved as a result.

A measure common to all algorithms may be used. Every algorithm may then be able to compute its own value on the basis of this measure. The resulting triggering time may then be calculated from the results of the algorithms. Due to the feature that the measure is common to all algorithms, arbitrary algorithms may be combined with one another. This may make the overall algorithm scalable and allow for its modular construction. Such a measure common to all algorithms may be, for example, the severity of the crash. This may be expressed, for example, in terms of the velocity reduction, the forward displacement or the buckling of the vehicle. The triggering time itself, may be calculated specifically for the particular restraint device concerned. Alternatively, other, e.g. abstract measures may be used as well.

The example method and measure described below are also intended to provide an adaptation of the triggering time, optimized for the standard occupant in a standard sitting position, to the particular occupant in the current sitting position. In this regard, it may be desirable that all information about the particular occupant provided by the passenger-compartment sensor systems is taken into account (e.g. fastened seatbelt, unfastened seatbelt, seatbelt extension, age of person, pregnant occupant detection, child-seat detection, etc.).

The at least one sensor signal may be derived from pre-crash sensors such as radar, ultrasound or video sensors and from crash sensors, e.g. acceleration sensors, which may be located in the control unit for the restraint devices and outside the control unit, for example, as upfront sensors at the radiator or as side-impact sensors in the sides of the vehicle. As for the side-impact sensors, sensors such as pressure sensors or other deformation sensors may be used as well. In this context, the following algorithms may be used: a pre-crash algorithm, e.g., an algorithm that evaluates the pre-crash signals from radar, video and ultrasound sensors, a central algorithm for evaluating the sensor signals in the central control unit, a side-impact algorithm for evaluating the sensor signals relevant for a side collision, an upfront algorithm for evaluating the sensor signals of the upfront sensors and a rollover algorithm for evaluating a rollover event, for example, on the basis of sensor signals from acceleration and rotational rate sensors. Additional algorithms may be provided in this connection.

The crash severity may exist as a scalable value, as a vector or as a matrix for the purpose of determining the common measure. The crash severity in this context may refer to the crash type, e.g. frontal, offset, side, rear end or rollover, or to the restraint device, e.g. seatbelt tensioner, front airbag, side airbag.

An example device may be provided for implementing the example method, that is, a control unit having a processor and the required sensors as well as the triggering for the restraint devices and the restraint devices themselves. Restraint devices may be, for example, air bags, rollover bars and seatbelt tensioners.

### BRIEF DESCRIPTION OF THE DRAWINGS

FIG. 1 shows a block diagram of an example device according to the present invention.

FIG. 2 shows a flowchart of the example method according to the present invention.

FIG. 3 shows a block diagram of the example method according to the present invention.

### DETAILED DESCRIPTION

A single frontal algorithm may be used to determine the triggering decision of restraint devices in a vehicle, or this algorithm may be individually combined with additional algorithms, e.g. for sensing a rollover or a side crash. The frontal algorithms may be based on a special sensor, e.g. the central acceleration sensor, the upfront sensor or the pre-crash sensor, and are named in accordance with the associated sensor system. If a frontal algorithm is used alone, the triggering time may be calculated directly. If a combination with other algorithms is used, the triggering time may be determined with the aid of a logic specially adapted to this combination. This logic may determine which algorithm decides regarding the triggering or non-triggering of the restraint device. Furthermore, the triggering times may refer to standardized persons, the 50% man, in a standardized sitting position. Thus, the triggering times may be exclusively defined in terms of vehicle-specific properties and not in terms of person-specific or sitting position-specific properties.

The present invention provides an example method for triggering restraint devices having a scalable and modular structure such that arbitrary algorithms may be combined with one another. For this purpose, an example measure may be defined which is common to all algorithms, the central, upfront, pre-crash, side, rollover and occupant algorithms, respectively, and which allows for the resulting triggering time to be calculated from the partial results. Furthermore, the triggering time optimized for the standard occupant in the standard sitting position may be adjusted to the particular occupant in the current sitting position. At this point, all information regarding the occupant may be required to be provided by the passenger-compartment sensor system. Such information may include, for example, the state of the seatbelt, the extension of the seatbelt, the age of the person, whether the person is pregnant and a signal from a child-seat detection device. Thus, for example, in the case of a light crash, the airbag should not be triggered for a small person leaning significantly forward. Thus, an example method may allow a modular and scalable algorithm to determine the definitive triggering time for the particular occupant in his/her particular sitting position from the results calculated from the partial algorithms.

The example method may provide calculation of a measure that is common to all partial algorithms and that allows for the calculation of the resulting triggering time. This may be pursued in two steps. At first, this measure may be specific only to the vehicle. That is, a standard occupant in the standard sitting position may be used as a basis for the calculation. In a second step, the actual passenger compartment information, for example, the sitting position and size or weight, may also be taken into account. In the end, therefore, this example method may provide a vehicle-specific and an occupant-specific measure. In this regard, the overall algorithm for controlling the restraint systems may be constructed in a modular and scalable manner and the current situation of the person to be protected may also be taken into account. This may put the person to be protected with his/her particular characteristics and in his/her current situation at the center of the triggering decision to be determined.

Every algorithm may be required to be able to calculate the measure independently of whether it is a front, side or rollover algorithm, and the example measure may be required to be common to all of them. Since the crash severity may represent the most suitable basis for ascertaining the triggering time, it may be used as this measure, for example. To this end, the crash severity may be expressed in terms of the velocity reduction, the forward displacement or the buckling of the vehicle. Another example measure may be the triggering time itself, which has been calculated for the particular restraint device. Alternatively, other abstract measures may be used as well. To this end, the crash severity may be a scalar number, a vector or a matrix. It may be a vector or a matrix if it is considered from various aspects. An aspect, for example, may be the crash severity which the individual algorithms have determined. Another aspect may be what the crash severity refers to, e.g. a front or side impact or a rollover. The crash severity, however, may also refer concretely to a specific restraint device, for example the side airbag, the front airbag or the seatbelt tensioner. If several aspects are considered simultaneously, this may result in a correspondingly multidimensional matrix. The crash severity, however, may also be recorded as a scalar number. In that case, all aspects may be required to be combined into one value.

In addition, a distinction may be required to be made between the crash severity as it applies specifically to the vehicle and only to a standard occupant and the crash severity which adjusts the vehicle-specific crash severity to the particular occupant in his/her current situation. This latter crash severity may be referred to as occupant-specific crash severity. To this end, all available information from the passenger compartment regarding the occupant may be required to be drawn upon as well. This may be, for example, the sitting position, the weight or the size of the occupant.

The triggering decision for the various restraint devices may be determined from the crash-severity matrix with the aid of a triggering logic. In this manner, for example, a high crash severity of one of the algorithms and a low crash severity of another algorithm may result in the triggering of one of the restraint devices and the suppression of another restraint device.

With the aid of this triggering logic, for example, restraint devices may be triggered even in cases in which the pre-crash sensor system failed to register an object, the pre-crash algorithm was not activated, yet the crash was registered by the central acceleration sensor system. Thus, if the centrally sensing algorithm, for example, ascertains a significantly higher crash severity than the pre-crash algorithm, then the suitable restraint devices may be triggered nevertheless. Hence it may be possible to construct a fallback strategy.

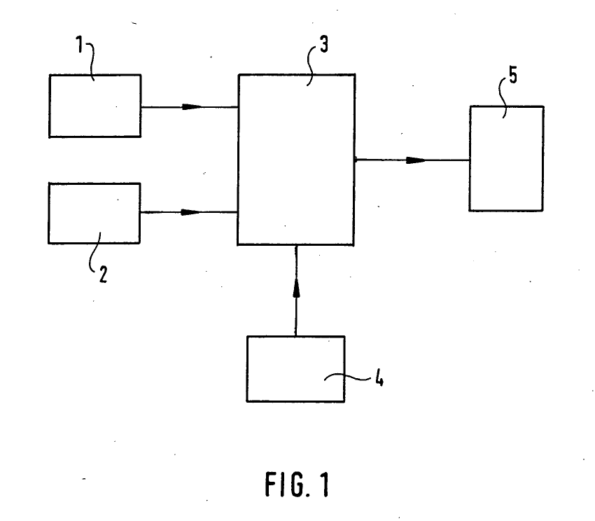

FIG. 1 shows an example device according to the present invention in a block diagram. A crash sensor system 1 and a pre-crash sensor system 2 are each connected to a control unit 3 for restraint devices. In this example, crash sensor system 1 represents external crash sensors such as acceleration sensors, deformation sensors or indirect deformation sensors such as pressure sensors. These sensors may be located in the sides of the vehicle and also at the radiator in the form of upfront sensors. Additional crash sensors for plausibilization or for crash detection may be contained within control unit 3 itself. Pre-crash sensor system 2 in this example represents radar or other environmental sensors such as video or ultrasound sensors. They may be mounted at the front end or at the rear end of the vehicle, for example. A passenger-compartment sensor system 4 is connected to control unit 3 via a third data input. Passenger-compartment sensor system 4 may be made up of weight-based sensors such as load-sensing bolts installed at the seat, or a seat mat or wave-based sensor systems that examine the person on the seat with the aid of infrared, ultrasound or radar, for example. Other sensor principles may be used in this connection. An important point may be here to recognize the person per se, as classified by his weight, and his sitting position. In addition to the crash sensor system already mentioned, control unit 3 also contains evaluation electronics in the form of a processor and redundant evaluation modules. Such redundant evaluation modules as safety semiconductors, for example, may evaluate the sensor signals independently of the processor and thus implement a plausibilization and a redundancy vis-à-vis the actual processor, which may take the form, for example, of a microcontroller. Control unit 3 additionally features an ignition circuit control for restraint devices 5 for triggering restraint devices 5 accordingly. Control unit 3 also features interface modules to individual sensors 1, 2 and 4 as well as to restraint devices 5. These interface modules may implement point-to-point connections or also bus connections. In the latter case, the interface modules are bus controllers.

According to an example embodiment of the present invention, control unit 3 now evaluates the sensor signals of sensor systems 1, 2 and 4 in such a manner that it processes different algorithms with the sensor signals in order and then to combine the values of these individual algorithms into a measure, which is then modified as a function of a signal of passenger-compartment sensor system 4 in order finally to trigger restraint devices 5 as a function of the modified measure. This measure determines when to trigger which restraint devices.

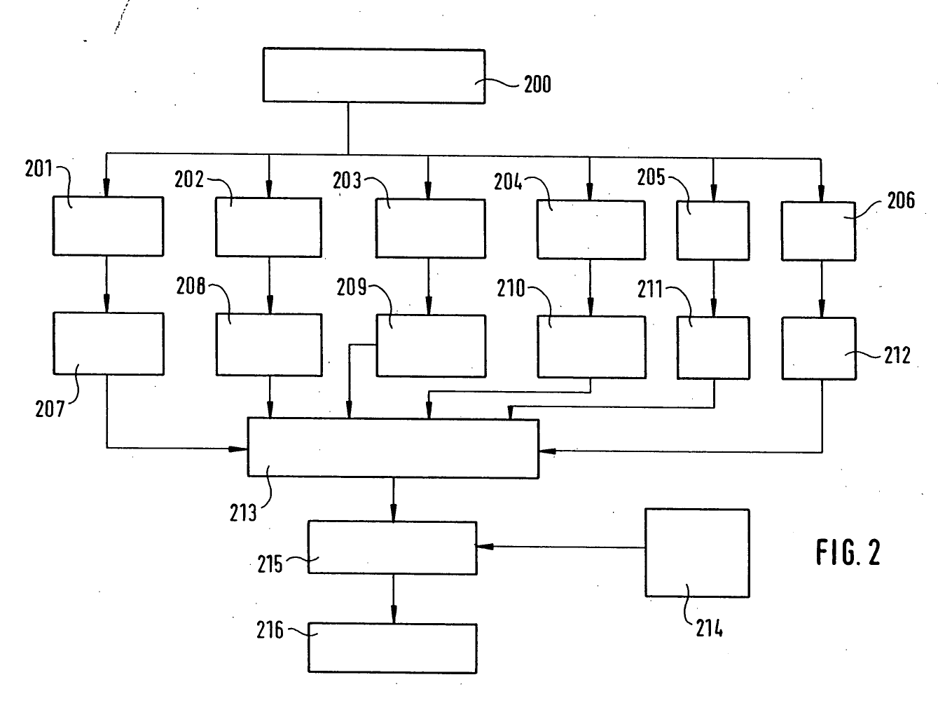

FIG. 2 shows the sequence of an example method according to the present invention in a flowchart. The sensor signals of sensor systems 1, 2 and 4 are generated in method step 200. In method step 201, the front algorithm is processed using these sensor signals, which then provides value 207 as a function of this sensor signal. In this context, value 207 represents the crash severity as well as the remaining values of the other algorithms. The upfront algorithm is processed in method step 202, providing value 208. The side-impact algorithm is processed in method step 203, providing value 209. The rear-impact algorithm is processed in method step 204, providing value 210. The rollover algorithm is processed in method step 205, outputting value 211, while the pre-crash algorithm is processed in method step 206, furnishing value 212. These values are combined in method step 213, for example, in the form of a weighted sum, so as to determine, for instance, the crash severity as the measure. In method step 215, this measure is then modified as a function of the signal from passenger-compartment sensor system 4 so as to adjust the measure to the current sitting position and to the particular person. As a function of the measure thus modified, restraint devices 5 are then triggered in method step 216. Ultimately, the measure then determines the triggering time and which restraint devices are triggered.

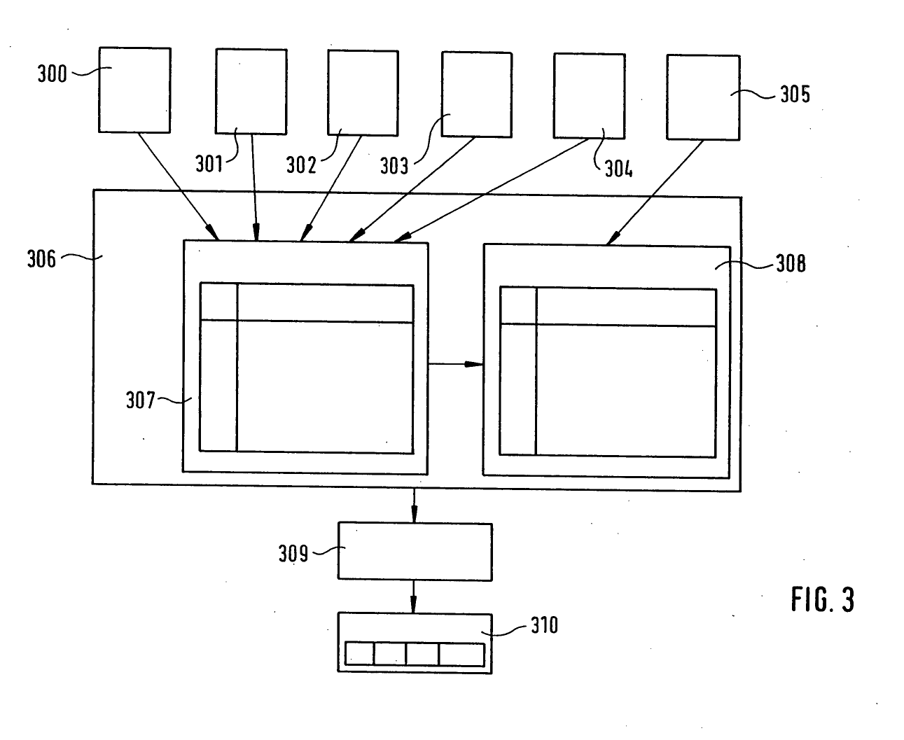

FIG. 3 shows a block diagram of an example method according to the present invention. In method step 306, a central algorithm 300, an upfront algorithm 301, a pre-crash algorithm 302, a side-impact algorithm 303 and a rollover algorithm 304 are drawn upon using a matrix 307 to determine the crash severity. This matrix is then modified in method step 308 as a function of the signal of the passenger-compartment sensor system algorithm. The crash severity thus forms a measure, which in method step 309 is fed to a logic, which, in method step 310, in turn leads to a decision to trigger the relevant restraint devices as a function of this measure.

1-10. (canceled)

11. A method for triggering a restraint device, comprising:
determining values, in accordance with a plurality of algorithms, as a function of at least one sensor signal from a passenger-compartment sensor system;
combining the values to form a measure influenced by the at least one sensor signal; and
triggering the restraint device as a function of the one measure.

12. The method of claim 11, further comprising determining a triggering time and a type of restraint device as a function of the measure.

13. The method of claim 11, wherein the algorithms use a common measure.

14. The method of claim 13, wherein the measure is a crash severity.

15. The method of claim 14, further comprising ascertaining the crash severity as one of a velocity reduction and a forward displacement.

16. The method of claim 11, further comprising generating the at least one sensor signal via at least one of a pre-crash sensor system and a crash sensor system.

17. The method of claim 11, wherein the plurality of algorithms include at least two of the following algorithms:
a pre-crash algorithm, a frontal algorithm, a side-impact algorithm, an upfront algorithm and a rollover algorithm.

18. The method of claim 14, further comprising using the crash severity one of in a scalar manner, as a vector, and as a matrix.

19. The method of claim 14, wherein the crash severity is specific to one of a used algorithm, a crash type, and the restraint devices.

20. A device for triggering a restraint devices, comprising:
an arrangement to determine values as a function of at least one sensor signal from a passenger-compartment sensor system using a plurality of algorithms;
an arrangement to combine the algorithms to form a measure influenced by the at least one sensor signal; and
an arrangement to trigger the restraint device as a function of the one measure.
